(19) United States
(12) Patent Application Publication
(10) Pub. No.: US 2020/0364954 A1
(43) Pub. Date: Nov. 19, 2020

(54) MAINTENANCE DEVICE CONTROL SYSTEM, MAINTENANCE DEVICE CONTROL METHOD, AND PROGRAM

(71) Applicant: OPTIM CORPORATION, Saga (JP)

(72) Inventor: Shunji SUGAYA, Tokyo (JP)

(21) Appl. No.: 16/651,732

(22) PCT Filed: Sep. 28, 2017
(86) PCT No.: PCT/JP2017/035307

§ 371 Date: Jul. 2, 2020

(51) Int. Cl. G07C 5/08; G07C 5/00; B64D 45/00; G06T 7/00; B64C 39/02; G06N 20/00

(52) U.S. Cl. CPC G07C 5/0808; G07C 5/006; G07C 5/008; B64D 45/00; B64C 2201/127; B64C 39/024; G06N 20/00; B64D 2045/0085; G06T 7/0002

(57) ABSTRACT

Provided are a maintenance device control system, a maintenance device control method and a storage medium. The maintenance device control system controls a maintenance device to perform maintenance, and is provided with: an image acquisition unit for acquiring an image photographed by an unmanned aerial vehicle; a failure determination unit for analyzing the image to determine a failure of a photographed object; a position estimation unit for estimating a position of the photographed object for which the failure has been determined; and a device control unit for controlling the maintenance device to perform maintenance on the failure of the photographed object in the estimated position.

### CROSS-REFERENCE TO RELATED APPLICATIONS

This patent application is a national phase under 35 U.S.C. § 371 of International Patent Application No. PCT/JP2017/035307 filed Sep. 28, 2017, which is hereby incorporated herein by reference in its entirety for all purposes.

### TECHNICAL FIELD

The present disclosure relates to a maintenance device control system which controls a maintenance device to perform maintenance, a maintenance device control method and a storage medium.

### BACKGROUND

In recent years, the maintenance technology using an unmanned aerial vehicle (UAV) has been improved in terms of efficiency. For example, an inspection system for an inside of a facility using an UAV has been provided, which allows an operator to inspect a device installed in the facility without going to the site (Patent Literature 1).

### LITERATURE IN THE RELATED ART

Patent Literature 1: Japanese Patent Publication No. 2017-154577

### SUMMARY

The present disclosure is directed to a maintenance control system, a maintenance device control method, a non-transitory computer-readable storage medium and a program. The disclosure provides a maintenance device control system. The maintenance device control system controls a maintenance device to perform maintenance, and is provided with: an image acquisition unit for acquiring an image photographed by a UAV; a failure determination unit for analyzing the image to determine a failure of a photographed object; a position estimation unit for estimating a position of the photographed object for which the failure has been determined; and a device control unit for controlling the maintenance device to perform maintenance on the failure of the photographed object in the estimated position.

The disclosure further provides a maintenance device control method. The maintenance device control method controls a maintenance device to perform maintenance, and includes: an image acquisition step for acquiring an image photographed by an unmanned aerial vehicle; a failure determination step for analyzing the image to determine a failure of a photographed object; a position estimation step for estimating a position of the photographed object for which the failure has been determined; and a device control unit step for controlling the maintenance device to perform maintenance on the failure of the photographed object in the estimated position.

The disclosure further provides a program. The program is used for executing the following steps: an image acquisition step for acquiring an image photographed by an unmanned aerial vehicle; a failure determination step for analyzing the image to determine a failure of a photographed object; a position estimation step for estimating a position of the photographed object for which the failure has been determined; and a device control unit step for controlling the maintenance device to perform maintenance on the failure of the photographed object in the estimated position.

### BRIEF DESCRIPTION OF THE DRAWINGS

FIG. 1 is a schematic diagram of a maintenance device control system.

FIG. 2 shows an example of a track for which a failure is determined.

### DETAILED DESCRIPTION

Optimum embodiments for implementing the present disclosure will be described below. It is to be noted that the embodiments are only examples and not intended to limit the scope of the present disclosure.

The maintenance device control system of the present disclosure is configured to control a maintenance device to perform maintenance on an object.

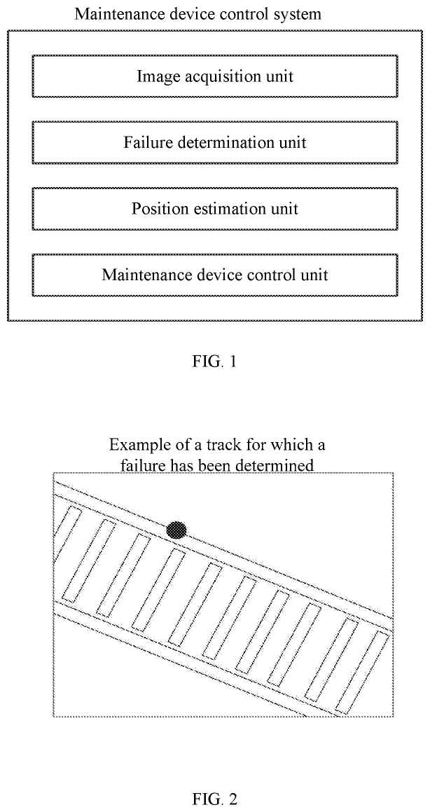

FIG. 1 is a view illustrating a maintenance device control system as an embodiment of the present disclosure.

As shown in FIG. 1, the maintenance device control system includes an image acquisition unit, a failure determination unit, a position estimation unit and a maintenance device control unit, which are implemented by a control unit which reads a specified program. The system may also include a UAV control unit (not shown). These units may be application-based, cloud-based or the like. The units described above may be implemented by a single computer, or may be implemented by two or more computers (for example, a server and a terminal).

The image acquisition unit is configured to acquire an image photographed by a camera of a UAV. The image may be dynamic or static. The camera may be any camera mounted on the UAV, such as a digital camera or a smartphone camera. In order to perform real-time maintenance, the image may be captured in real-time.

The failure determination unit is configured to analyze the image to determine a failure of a photographed object. The accuracy of image analysis may be improved through machine learning. For example, the machine learning may be performed by using images photographed in the past as teacher data. For example, as shown in FIG. 2, a failure of a track may be determined through image analysis. Of course, the image analysis is not limited to be used for determining the failure of the track, but determining the failure of buildings, roads, terminals and the like. For example, compared to the case in which an operator on the site determines a failure while walking near the track, the efficiency can be significantly improved by analyzing the image photographed by the UAV to determine the failure.

Further, the failure determination unit may also analyze the image, and when a size satisfies a specified condition, determine the failure of the photographed object. For example, when the size of the track is greater than or less than a reference value, there may be a risk of derailment. In this case, the track is determined to have the failure.

Further, the failure determination unit may also analyze the image, and when a color satisfies a specified condition, determine the failure of the photographed object. For example, when the color of the track is lighter or darker than a reference value, if the track is damaged due to rusting, there may be a risk of derailment. In this case, the track is determined to have the failure.

Further, the failure determination unit may also analyze the image, and when a shape satisfies a specified condition, determine the failure of the photographed object. For example, when the size of the track is greater than or equal to a reference value, there may be a risk of derailment. In this case, the track is determined to have the failure.

The position estimation unit is configured to estimate a position of the photographed object for which the failure has been determined. The position of the photographed object for which the failure has been determined may be estimated according to a GPS position, a photographing height, a photographing angle and a photographing direction of the UAV. For example, in a case of a photographing height H and a photographing angle θ, the position of the photographed object for which the failure has been determined is a latitude/longitude obtained by adding H tan θ to the latitude/longitude of the GPS position in consideration of the photographing direction.

The device control unit is configured to control the maintenance device to perform maintenance on the failure of the photographed object in the estimated position. For example, the maintenance device for a track may be controlled to perform maintenance on the track in the estimated position. For example, a maintenance-dedicated UAV may be controlled to perform maintenance on the track in the estimated position. The photography-dedicated UAV and the maintenance-dedicated UAV are used separately, so as to perform maintenance with high efficiency.

The UAV control unit is configured to control the UAV to fly to the estimated position and photographs the object again. For example, since the failure determination could be a wrong determination, in order to care the wrong determination, the UAV flies to take an image again. The image photographed again is analyzed, such that a double check for failure determination is performed.

### Description of Operations

The maintenance device control method is described below. The maintenance device control method of the present disclosure is a method for controlling a maintenance device to perform maintenance on a photographed object for which the failure has been determined.

The maintenance device control method includes an image acquisition step, a failure determination step, a position estimation step and a device control unit step. Further, the method may also include a UAV control step.

In the image acquisition step, an image photographed by a camera of a UAV is acquired. The image may be dynamic or static. The camera may be any camera mounted on the UAV, such as a digital camera or a smartphone camera. In order to perform real-time maintenance, the image may be captured in real-time.

In the failure determination step, the image is analyzed to determine a failure of a photographed object. The accuracy of image analysis may be improved through machine learning. For example, the machine learning may be performed by using images photographed in the past as teacher data. For example, as shown in FIG. 2, a failure of a track may be determined through image analysis. Of course, the image analysis is not limited to be used for determining the failure of the track, but determining the failure of buildings, roads, terminals and the like. For example, compared to the case in which an operator on the site determines a failure while walking near the track, the efficiency can be significantly improved by analyzing the image photographed by the UAV to determine the failure.

Further, in the failure determination step, the image is analyzed, and when a size satisfies a specified condition, the failure of the photographed object is determined. For example, when the size of the track is greater than or equal to a reference value, there may be a risk of derailment. In this case, the track is determined to have the failure.

Further, in the failure determination step, the image is analyzed, and when a color satisfies a specified condition, the failure of the photographed object is determined. For example, when the color of the track is lighter or darker than a reference value, if the track is damaged due to rusting, there may be a risk of derailment. In this case, the track is determined to have the failure.

Further, in the failure determination step, the image is analyzed, and when a shape satisfies a specified condition, the failure of the photographed object is determined. For example, when the size of the track is greater than or equal to a reference value, there may be a risk of derailment. In this case, the track is determined to have the failure.

In the position estimation step, a position of the photographed object for which the failure has been determined is estimated. The position of the photographed object for which the failure has been determined may be estimated according to a GPS position, a photographing height, a photographing angle and a photographing direction of the UAV. For example, in a case of a photographing height H and a photographing angle θ, the position of the photographed object for which the failure has been determined is a latitude/longitude obtained by adding H tan θ to the latitude/longitude of the GPS position in consideration of the photographing direction.

In the device control step, the maintenance device is controlled to perform maintenance on the failure of the photographed object in the estimated position. For example, the maintenance device for a track may be controlled to perform maintenance on the track in the estimated position. For example, a maintenance-dedicated UAV may be controlled to perform maintenance on the track in the estimated position. The photography-dedicated UAV and the maintenance-dedicated UAV are used separately, so as to perform maintenance with high efficiency.

In the UAV control step, the UAV is controlled to fly to the estimated position and photographs the object again. For example, since the failure determination could be a wrong determination, in order to care the wrong determination, the UAV flies to take an image again. The image photographed again is analyzed, such that a double check for failure determination is performed.

The above units and functions are implemented by reading and executing a specified program by a computer (including a central processing unit (CPU), an information processing apparatus and various terminals). The program may be, for example, an application installed in a computer, may be provided from the computer via a network in form of a software as a service (SaaS) system provided, or may be provided in a form of being recorded on a computer-readable recording medium such as a flexible disk, a compact disk (CD) (such as a compact disc read-only memory (CD-ROM)), and a digital versatile disc (DVD) (such as a digital versatile disc read-only memory (DVD-ROM) and a digital versatile disc random access memory (DVD-RAM)). In this case, the computer reads the program from the recording medium and transfers the program to an internal storage device or an external storage device for storage and execution. Further, the program may also be previously recorded on a storage apparatus (recording medium) such as a magnetic disk, an optical disk or a magneto-optical disk, and provided from the storage apparatus for the computer via a communication line.

The specific algorithm of the machine learning described above may be a nearest neighbor algorithm, a naive Bayes model, a decision tree, a support vector machine, reinforcement learning or the like. Further, it may also be deep learning in which the characteristic quantities for learning are generated by using a neural network.

The embodiments of the present disclosure have been described above, but the present disclosure is not limited to the above-mentioned embodiments. In addition, the effects described in the embodiments of the present disclosure are merely illustrative of the best effects produced by the present disclosure, and the effects of the present disclosure are not limited to the effects described in the embodiments of the present disclosure.

1-8. (canceled)

9. A maintenance device control system, which controls a maintenance device to perform maintenance, wherein the maintenance device control system comprises:
a processor; and
a memory for storing instructions executable by the processor,
wherein when executing the instructions, the processor is configured to:
acquire an image photographed by an unmanned aerial vehicle;
analyze the image to determine a failure of a photographed object, and perform machine learning with a former image to increase accuracy of image analysis;
estimate a position of the photographed object for which the failure has been determined; and
control the maintenance device to perform maintenance on the failure of the photographed object in the estimated position.

10. The maintenance device control system of claim 9, wherein the processor is configured to analyze the image, and in response to determining that a size satisfies a prescribed condition, determine that the photographed object has a failure.

11. The maintenance device control system of claim 9, wherein the processor is configured to analyze the image, and in response to determining that a color satisfies a specified condition, determine the failure of the photographed object.

12. The maintenance device control system of claim 9, wherein the processor is configured to analyze the image, and in response to determining that a shape satisfies a specified condition, determine the failure of the photographed object.

13. The maintenance device control system of claim 9, wherein the processor is configured to estimate the position of the photographed object for which the failure has been determined according to a GPS position, a photographing height, a photographing angle and a photographing direction of the unmanned aerial vehicle.

14. The maintenance device control system of claim 9, wherein the processor is further configured to:
control the unmanned aerial vehicle to fly to the estimated position and photographs the object again.

15. A maintenance device control method, which controls a maintenance device to perform maintenance, wherein the maintenance device control method comprises:
an image acquisition step for acquiring an image photographed by an unmanned aerial vehicle;
a failure determination step for analyzing the image to determine a failure of a photographed object, and performing machine learning with a former image to increase accuracy of image analysis;
a position estimation step for estimating a position of the photographed object for which the failure has been determined; and
a device control unit step for controlling the maintenance device to perform maintenance on the failure of the photographed object in the estimated position.

16. A non-transitory computer-readable storage medium for storing a program, wherein when executed by a processor, the program executes:
an image acquisition step for acquiring an image photographed by an unmanned aerial vehicle;
a failure determination step for analyzing the image to determine a failure of a photographed object, and performing machine learning with a former image to increase accuracy of image analysis;
a position estimation step for estimating a position of the photographed object for which the failure has been determined; and
a device control unit step for controlling the maintenance device to perform maintenance on the failure of the photographed object in the estimated position.
